(19) United States
(12) Patent Application Publication
(10) Pub. No.: US 2003/0043215 A1
(43) Pub. Date: Mar. 6, 2003

(54) Portable information terminal, information display control method, recording medium, and program

(75) Inventors: Hideki Nomura, Tokyo (JP); Tomoyuki Shudo, Kanagawa (JP); Satoshi Otsuka, Kanagawa (JP); Mitsuhiro Miyazaki, Kanagawa (JP); Kazuhide Sasamoto, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Sony Corporation, Tokyo (JP)

(21) Appl. No.: 10/231,075

(22) Filed: Aug. 30, 2002

(30) Foreign Application Priority Data
Aug. 31, 2001 (JP) 2001-263778

(51) Int. Cl. G09G 5/00

(52) U.S. Cl. 345/864

(57) ABSTRACT

If the user performs a manipulation for enlarging a first frame, after a lapse of t1 seconds, the display region of the first frame is enlarged and only the characters “Ja” of onomatopoeic characters “Jaaan!!” are displayed at a bottom-right position of the display region of the first frame. After a lapse of t2 seconds, the display region of the first frame is further enlarged and the characters “Jaaa” of the onomatopoeic characters “Jaaan!!” are displayed in such a manner as to have moved leftward from the previous position. After a lapse of t3 seconds, the display region of the first frame is even further enlarged and all the onomatopoeic characters “Jaaan!!” are displayed in such a manner as to have moved leftward from the previous position.

### BACKGROUND OF THE INVENTION

1. Field of the Invention

The present invention relates to a portable information terminal, an information display control method, a recording medium, and a program. In particular, the invention relates to a portable information terminal and an information display control method capable of increasing legibility in the case where information is displayed on a small screen that is provided in a PDA (personal digital assistant), a digital cellular phone, or the like, as well as to a related recording medium and program.

2. Description of the Related Art

Flash-memory-based memory cards can store music, video, computer programs, and other contents. For example, it is possible to convert images of a comic story of a comic book into digital data (comic data) and to store the digital data in a memory card. By inserting a memory card in which comic story data are stored into a portable information terminal such as a PDA or a digital cellular phone, the user can enjoy the comic story on the screen.

However, since portable information terminals are designed so as to be small to allow users to carry those easily, their display sections should also be made small. If the entire image of one page that includes a plurality of frames is displayed on the screen, the legibility of individual comic pictures and words will be low.

One method for solving the above problem would be to increase legibility by displaying one frame, rather than one page, on the screen each time. However, in this case, a user needs to perform frame-feed manipulations laboriously; the operability is low.

### SUMMARY OF THE INVENTION

The present invention has been made in view of the above circumstances in the art, and an object of the invention is therefore to increase legibility by displaying only a prescribed frame in an enlarged manner.

A portable information terminal according to the invention comprises reading means for reading image data that are stored in a memory card; and display control means for performing a control so as to display a one-page image corresponding to the image data that have been read by the reading means, and to enlarge a prescribed one of a plurality of frames that are included in the one-page image.

The portable information terminal may further comprise computing means for analyzing the image data that have been read by the reading means and developing the image data into data having a prescribed data structure, wherein the display control means may enlarge the prescribed frame based on its developed data.

The portable information terminal may further comprise judging means for judging whether an enlargement event has occurred, the enlargement event being one of an input from a user for an enlarged display and a lapse of a prescribed time, wherein the display control means may enlarge the prescribed frame based on a judgment result of the judging means.

The display control means may control display of characters corresponding to an effect sound that is included in the prescribed frame in enlarging the prescribed frame.

The characters corresponding to the effect sound may be onomatopoeic characters.

The display control means may operate in such a manner as not to display the onomatopoeic characters during an ordinary display of the prescribed frame, and to display the onomatopoeic characters during an enlarged display of the prescribed frame.

The display control means may operate in such a manner as to display the onomatopoeic characters during an ordinary display of the prescribed frame, and to display plural sets of the onomatopoeic characters in such a manner that the plural sets of the onomatopoeic characters are superimposed on each other at least partially or arranged side by side during an enlarged display of the prescribed frame.

The portable information terminal may further comprise sound output means for outputting a sound corresponding to the onomatopoeic characters whose display is being controlled by the display control means when the prescribed frame is enlarged.

The image data may be comic data.

An information display control method according to the invention comprises a read control step of controlling reading of image data that are stored in a memory card; and a display control step of performing a control so as to display a one-page image corresponding to the image data that have been read by the read control step, and to enlarge a prescribed one of a plurality of frames that are included in the one-page image.

The invention provides a recording medium on which a program is recorded, the program comprising a read control step of controlling reading of image data that are stored in a memory card; and a display control step of performing a control so as to display a one-page image corresponding to the image data that have been read by the read control step, and to enlarge a prescribed one of a plurality of frames that are included in the one-page image.

A program according to the invention causes a computer to execute a read control step of controlling reading of image data that are stored in a memory card; and a display control step of performing a control so as to display a one-page image corresponding to the image data that have been read by the read control step, and to enlarge a prescribed one of a plurality of frames that are included in the one-page image.

In the portable information terminal, the information display control method, the recording medium, and the program according to the invention, image data stored in a memory card are read out, a one-page image corresponding to the read-out image data is displayed, and a prescribed one of a plurality of frames included in the one-page image is enlarged.

### BRIEF DESCRIPTION OF THE DRAWINGS

FIG. 1 shows an exemplary appearance of a PDA according to an embodiment of the present invention;

FIG. 2 is a block diagram showing an exemplary electrical configuration of the PDA of FIG. 1;

FIGS. 3A-3D show exemplary displays of a comic image;

FIGS. 4A-4E show onomatopoeic characters display methods;

FIG. 5 is a flowchart showing a comic data display process;

FIGS. 6-12 show exemplary displays of a comic image including a plurality of frames;

FIG. 13 shows an exemplary display of a one-frame comic image; and

FIGS. 14A and 14B show other exemplary displays of the one-frame comic image of FIG. 13.

### DESCRIPTION OF THE PREFERRED EMBODIMENTS

Embodiments of the present invention will be hereinafter described with reference to the accompanying drawings.

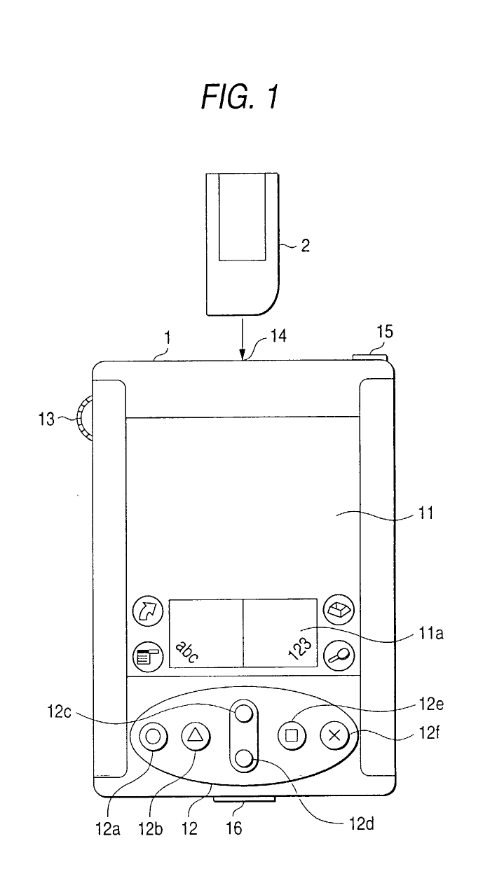

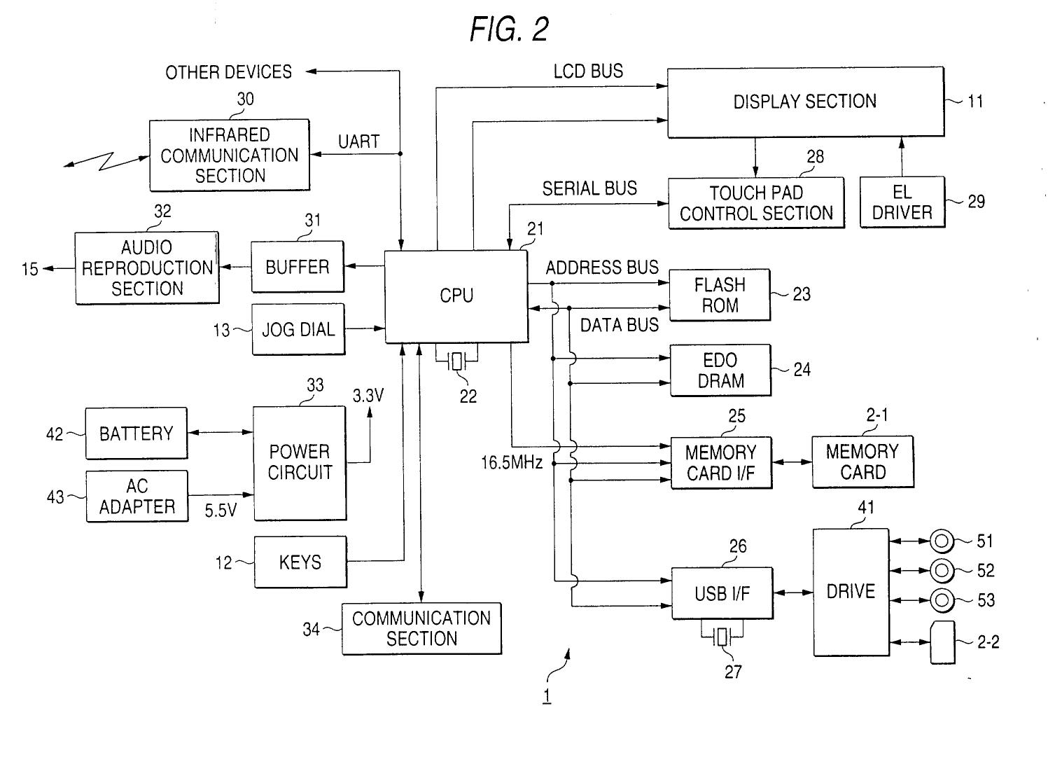

FIG. 1 shows an exemplary appearance of a PDA 1 according to an embodiment. The body of the PDA 1 has such a size as to be gripped and manipulated by one hand. The top portion of the PDA 1 is provided with a memory card slot 14 into which a memory card 2 is to be inserted and an infrared communication section 30 (see FIG. 2) that serves to exchange information with other devices by infrared communication. The PDA 1 may also be provided with a radio LAN communication section (not shown) or the like that enables radio communication according to Bluetooth (trademark).

For example, the memory card 2 shown in FIG. 1 is a flash memory card called “memory stick” (trademark) that was developed by the present assignee. The memory stick is such that a flash memory being a kind of EEPROM (electrically erasable programmable read-only memory) that is an electrically rewritable and erasable nonvolatile memory is housed in a small, thin plastic case measuring 50 mm(vertical)×21.5 mm (horizontal)×2.8 mm(thickness). It is possible to write and read various data such as images, voice, and music to and from the memory stick through 10 pins (terminals).

The memory stick employs its own serial protocol that can secure compatibility with devices using it even if the specification of the built-in flash memory is altered in association with increase in capacity, for example, and attains a maximum write rate of 1.5 MB/s and a maximum read rate of 2.45 MB/s. Further, the memory stick is highly reliable because it is equipped with an erroneous erasure preventive switch for preventing stored data from being erased erroneously.

Returning to FIG. 1, the bottom surface of the PDA 1 is provided with a modem (not shown) for connection to a public network, a USB (universal serial bus) port 16 or an RS-232C port (not shown) for exchange of various data, etc. The PDA 1 is also equipped with a display section 11, keys 12, a JOG dial 13, a headphone terminal 15, etc.

Being a thin display device such as a liquid crystal display device, the display section 11 displays images such as an icon, a thumbnail, and a text. A touch pad 11a is provided under the display section 11. The user inputs a desired operation instruction or data to a CPU 21 (see FIG. 2) of the PDA 1 by touching the display section 11 and the touch pad 11a with his finger, a pen, or the like.

Consisting of keys 12a-12f, the keys 12 are manipulated by the user when he inputs a desired operation instruction or data to the CPU 21. When the keys 12 are manipulated by the user, the CPU 21 activates a schedule table, an address book, a memo pad, or the like or scrolls an image on the screen.

For example, when a comic image (described later) is displayed on the display section 11, the image is scrolled leftward if the key 12a or 12b is manipulated, rightward if the key 12e or 12f is manipulated, upward if the key 12c is manipulated, and downward if the key 12d is manipulated.

For example, the JOG dial 13 is rotated or pushed toward the body side when the user selects an icon, a thumbnail, a text, or the like that is displayed on the display section 11 and decides on the selected item. For example, in a state that a plurality of icons are displayed on the display section 11, a desired icon is selected among the plurality of icons by rotating the JOG dial 13. The selected icon is decided by pushing the JOG dial 13 toward the body side. If the decided icon corresponds to an application program, the application program is activated.

An operation of rotating the JOG dial 13 while pushing it toward the body side may be associated with an instruction that is different from an instruction that is associated with ordinary rotation of the JOG dial 13. The correspondence between instructions and manipulations on the JOG dial 13 is not limited to the above.

The headphone terminal 15 serves to output, to a headphone (not shown), a sound that is supplied from an audio reproduction section 32 (see FIG. 2).

FIG. 2 is a block diagram showing an exemplary electrical configuration of the PDA 1.

The CPU 21 executes various program such as an operating system and application programs that are stored in a flash ROM (read-only memory) 23 and an EDO DRAM (extended data out dynamic random access memory) 24 in synchronism with a clock signal that is supplied from an oscillator 22.

Being a flash memory that is a kind of EEPROM, the flash ROM 23 generally stores programs to be used by the CPU 21 and basically fixed data among parameters for computation. The EDO DRAM 24 stores programs to be executed by the CPU 21 and parameters that vary as those programs are executed.

A memory card interface (I/F) 25 reads program data (i.e., comic data to be described later) from a memory card 2-1 that is inserted in the memory card slot 14 of the PDA 1. If necessary, the memory card interface 25 writes, to the memory card 2-1, data that are supplied from the CPU 21.

A USB interface 26 inputs, in synchronism with a clock signal that is supplied from an oscillator 27, data or a program from a drive 41 that is a USB device and is connected to the the USB interface 26 via the USB port 16. The USB interface 26 also supplies the drive 41 with data that are supplied from the CPU 21.

The drive 41 reads data or a program from a magnetic disk 51, an optical disk 52, a magneto-optical disc 53, or a memory card 2-2 that is mounted in the drive 41 when necessary, and supplies the data or program to the CPU 21 or the EDO DRAM 24 via the USB port 26. The drive 41 also records data or a program on the magnetic disk 51, optical disk 52, magneto-optical disc 53, or memory card 2-2 that is mounted in the drive 41.

The flash ROM 23, the EDO ROM 24, the memory card interface 25, and the USB interface 26 are connected to the CPU 21 via an address bus and a data bus.

The display section 11 receives data from the CPU 21 via an LCD bus and displays a picture, characters, or the like corresponding to the received data. When the display section 11 or the touch pad 11a is manipulated, a touch pad control section 28 receives data (indicating coordinates of a touched position, for example) corresponding to the manipulation from the display section 11 or the touch pad 11a and supplies a signal corresponding to the received data to the CPU 21 via a serial bus.

An EL (electroluminescence) driver 29 controls the brightness of the display section 11 by properly operating an electroluminescence device that is provided on the back side of a liquid crystal display section of the display section 11.

An infrared communication section 30 converts data received from the CPU 21 into an infrared signal and transmits it to another device (not shown) through a UART (universal asynchronous receiver-transmitter). Further, the infrared communication section 30 receives an infrared signal from another device and supplies resulting data to the CPU 21. The PDA 1 can communicate with another device only through the UART.

Being an audio data decoding circuit or the like, an audio reproduction section 32 decodes audio data that are stored in advance or received from another device and outputs a sound via the headphone terminal 15. For example, the audio reproduction section 32 decodes audio data that are supplied from the CPU 21 through a buffer 31 and outputs a corresponding sound to the headphone (not shown) via the headphone terminal 15.

A power circuit 33 converts a supply voltage that is supplied from a battery 42 that is provided in the PDA 1 or an AC (alternating current) adapter 43 that is connected to the PDA 1 and supplies necessary power to the CPU 21 to the audio reproduction section 32.

Being an interface of RS-232C or the like, a communication section 34 is connected to a communication module or the like. The communication section 34 is connected to the Internet or the like through the communication module, and produces packets according to a prescribed scheme based on data (e.g., an e-mail) that are supplied from the CPU 21 and transmits those to another device over the Internet. Further, the communication section 34 outputs, to the CPU 21, data or a program that is contained in packets that are received from another device over the Internet.

The memory card 2-1 or 2-2 stores comic data to be used for displaying a comic story on the display section 11 of the PDA 1. Comic data are data that are written according to the XML (extensible markup language) scheme, for example.

In the following description, each of the memory cards 2-1 and 2-2 will be called merely “memory card 2” as long as they need not be discriminated from each other.

Methods for storing comic data in the memory card 2 will be described. For example, comic data are stored in the memory card 2 by the following methods:

(1) The memory card 2 is inserted into the memory card slot of a personal computer and a CD-ROM (compact disc-read only memory) on which comic data are recorded is mounted in a drive of the personal computer. The comic data are copied (stored) from the CD-ROM to the memory card 2.

(2) The memory card 2 is inserted into the memory card slot of a personal computer or a digital cellular phone. Comic data are downloaded from a prescribed site over the Internet and stored in the memory card 2.

(3) The memory card 2 is inserted into the memory card slot 14 of the PDA 1. The PDA 1 is connected to a digital cellular phone and then connected to the Internet through the digital cellular phone. Comic data are downloaded from a prescribed site and stored in the memory card 2.

(4) The memory card 2 is inserted into the memory card slot 14 of the PDA 1. The PDA 1 is connected to a terminal that is provided in a store. Comic data are downloaded from a prescribed server through the terminal and stored in the memory card 2.

Comic data may be stored in the memory card 2 in advance by methods other than the above methods; Comic data may be stored in the memory card 2 by any method.

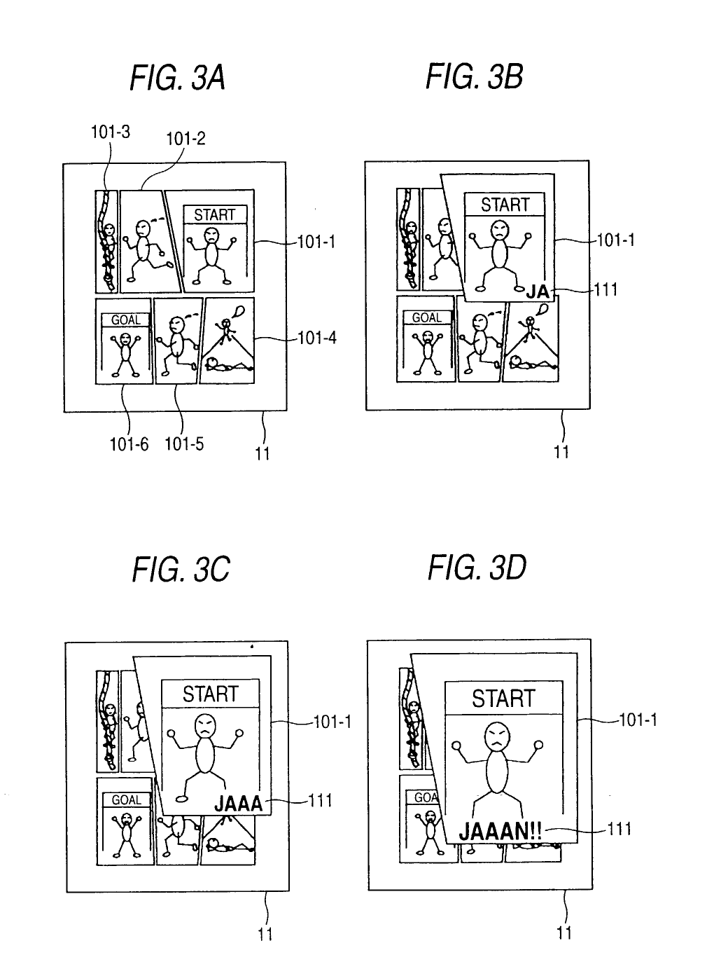

FIGS. 3A-3D show exemplary comic images to be displayed on the display section 11 of the PDA 1.

The comic image of FIG. 3A is displayed in the following manner. When an input to display, on the display section 11, a comic story corresponding to the comic data stored in the memory card 2 is received form the user, the CPU 21 reads comic data from the memory card 2 and analyzes an XML description of the comic data. As a result, the comic image of FIG. 3A is displayed.

The one-page comic image of FIG. 3A includes a plurality of frames 101-1 to 101-6. To make the first frame 101-1 easier to see, the user performs a manipulation for enlarging the frame 101-1 on the keys 12.

Based on a signal corresponding to an input (event), that is, the manipulation of the user, the CPU 21 performs a control so as to enlarge the frame 101-1. As a result, after a lapse of t1 seconds, for example, as shown in FIG. 3B the display region of the frame 101-1 shown in FIG. 3A is enlarged and only the characters “Ja” 111 of onomatopoeic characters “Jaaan!!,” for example, are displayed at a bottom-right position of the display region of the frame 101-1.

The term “onomatopoeic characters” are characters representing an artificial sound, an effects sound, or the like that is generated by simulating an actual sound and is not a word spoken by a human, such as “Jaaan,” “Jajajajaaan,” or “Tantan Taaan.”

After a lapse of t2 seconds, as shown in FIG. 3C, the display region of the frame 101-1 is further enlarged from the one shown in FIG. 3B and the characters “Jaaa” 111 of the onomatopoeic characters “Jaaan!!” are displayed in such a manner as to have moved leftward from the position in FIG. 3B. After a lapse of t3 seconds, as shown in FIG. 3D, the display region of the frame 101-1 is further enlarged from the one shown in FIG. 3C and the characters “Jaaan!!” 111 are displayed in such a manner as to have moved leftward from the position in FIG. 3C.

Similarly, if the user performs, in turn, manipulations for enlarging the second frames 101-2 to 101-6 on the keys 12 to make them easier to see, the frames 101-2 to 101-6 are enlarged in turn in the above-described manner.

As described above, even if a one-page comic image consisting of a plurality of frames is displayed on the display section 11 having a small display area, a frame that is selected by the user is enlarged and the legibility is thereby increased.

In the above example, the user performs manipulations of enlarging frames one by one. Alternatively, frames may be enlarged (fed) in turn by using a lapse of a prescribed time as a trigger. For example, the comic image of FIG. 3A is displayed on the display section 11 and the first frame 101-1 is enlarged after a lapse of a prescribed time. After a further lapse of the prescribed time (i.e., a preset, fixed time (e.g., 10 seconds) that is long enough for the user to understand the frame 101-1), the second frame 101-2 is enlarged.

Although in the above example the onomatopoeic characters 111 are moved leftward in the display region, the invention is not limited to such a case. Onomatopoeic characters may be moved rightward, upward, downward, or in a diagonal direction. The manner of movement is defined by an XML description.

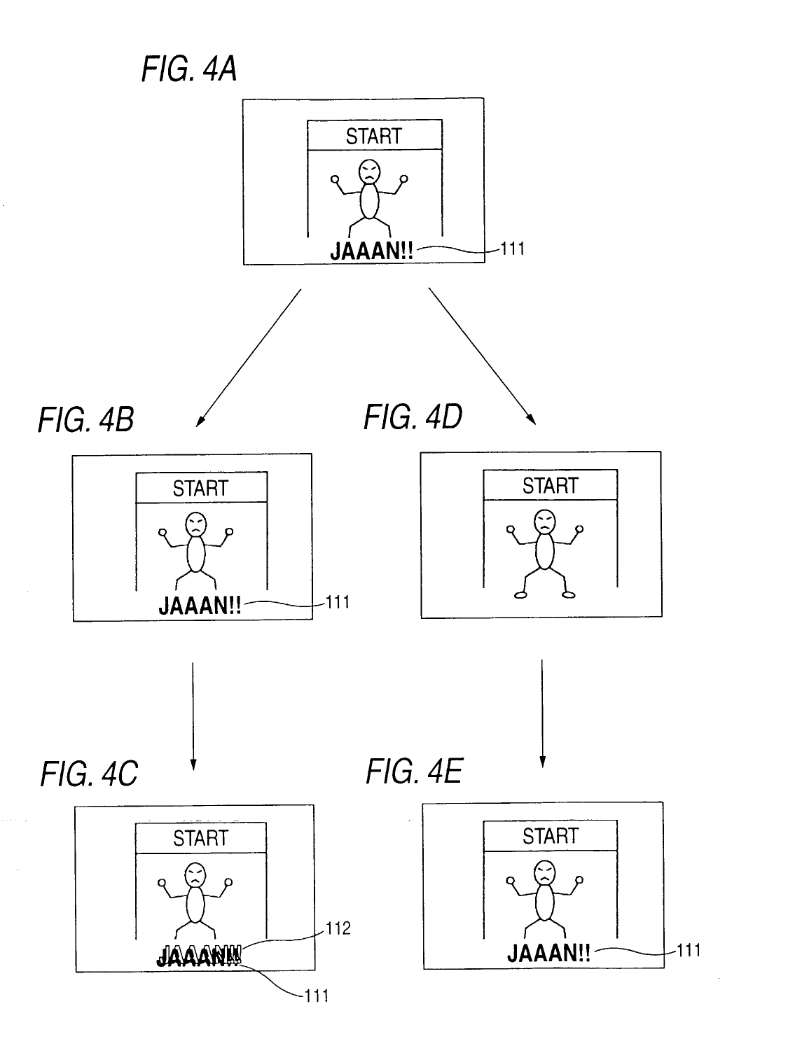

Next, how to display onomatopoeic characters will be described with FIGS. 4A-4E.

FIG. 4A shows the original picture of one frame of a comic story. Onomatopoeic characters “Jaaan!!” 111 are drawn in a bottom portion of the original picture. To effectively display the onomatopoeic characters 111, for example, as shown in FIG. 4B, the comic picture including the onomatopoeic characters 111 is displayed like the original picture when a comic image is displayed ordinarily (i.e., as a one-page image). When this frame is enlarged, as shown in FIG. 4C the onomatopoeic characters 111 are left and onomatopoeic characters 112 that are a copy of the onomatopoeic characters 111 are also displayed so as to overlap the onomatopoeic characters 111 or be placed by their side. The display positions of the onomatopoeic characters 111 and 112 are moved if necessary.

Alternatively, as shown in FIG. 4D, the onomatopoeic characters 111 are not displayed when a comic image is displayed ordinarily (i.e., as a one-page image). When this frame is enlarged, the onomatopoeic characters 111 are displayed as shown in FIG. 4E. Also in this case, the display position of the onomatopoeic characters 111 is moved if necessary.

As described above, even when the frame corresponding to the original picture is displayed ordinarily as part of a one-page comic image, the onomatopoeic characters 111 in the original picture are displayed. When the frame is enlarged, onomatopoeic characters 112 that are a copy of the onomatopoeic characters 111 are displayed so as to be placed by the side of the onomatopoeic characters 111 or be superimposed on the latter at least partially while the onomatopoeic characters 111 and 112 are moved if necessary (see FIG. 4C). Alternatively, the onomatopoeic characters 111 in the original image are not displayed when the frame corresponding to the original picture is displayed ordinarily as part of a one-page comic image. Only when the frame is enlarged, the onomatopoeic characters 111 are displayed while the onomatopoeic characters 111 and 112 are moved if necessary (see FIG. 4E). In either case, the onomatopoeic characters can be displayed effectively.

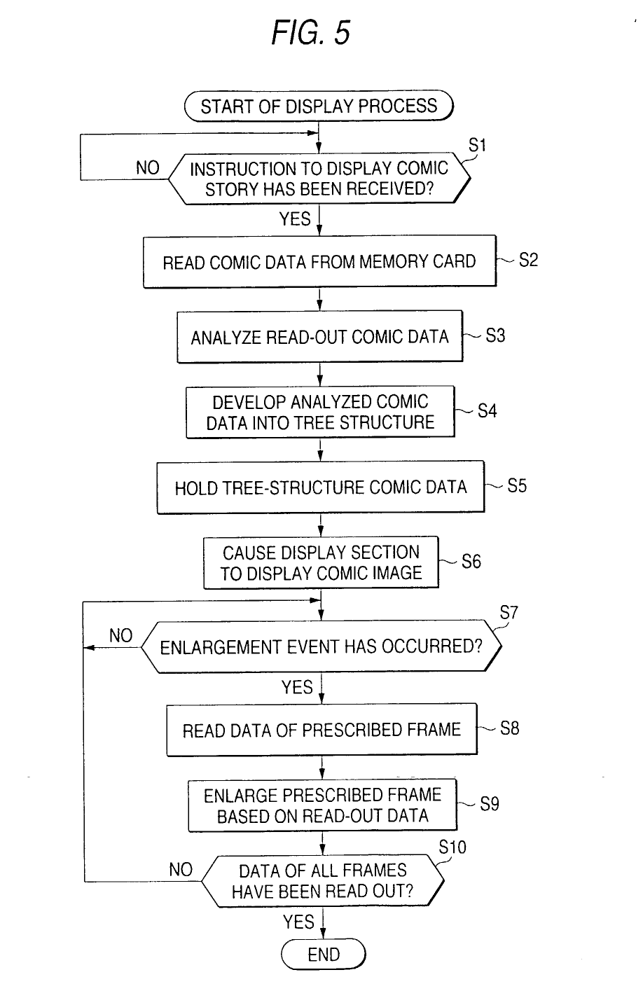

Next, the comic data display process will be described in more detail with reference to a flowchart of FIG. 5. It is assumed that the memory card 2 is inserted in the PDA 1 at a start of this process.

At step S1, the CPU 21 judges whether it has received, from the user, an instruction to display a comic story corresponding to comic data that are stored in the memory card 2. This judgment step is repeated until reception of an instruction to display a comic story.

If it is judged at step S1 that an instruction to display a comic story has been received, the process goes to step S2, where the CPU 21 reads, based on an instruction from the user, comic data that are stored in the memory card 2-1 through the memory card interface 25 or reads comic data that are stored in the memory card 2-2 through the USB port 26 and the drive 41.

At step S3, the CPU 21 analyzes an XML description of the comic data that were read out at step S2. At step S4, the CPU 21 develops, into a tree structure, the comic data that were analyzed at step S3. At step S5, the CPU 21 holds the comic data that were developed into the tree structure at step S4. As a result, the details of respective frames are held in the form of a tree structure.

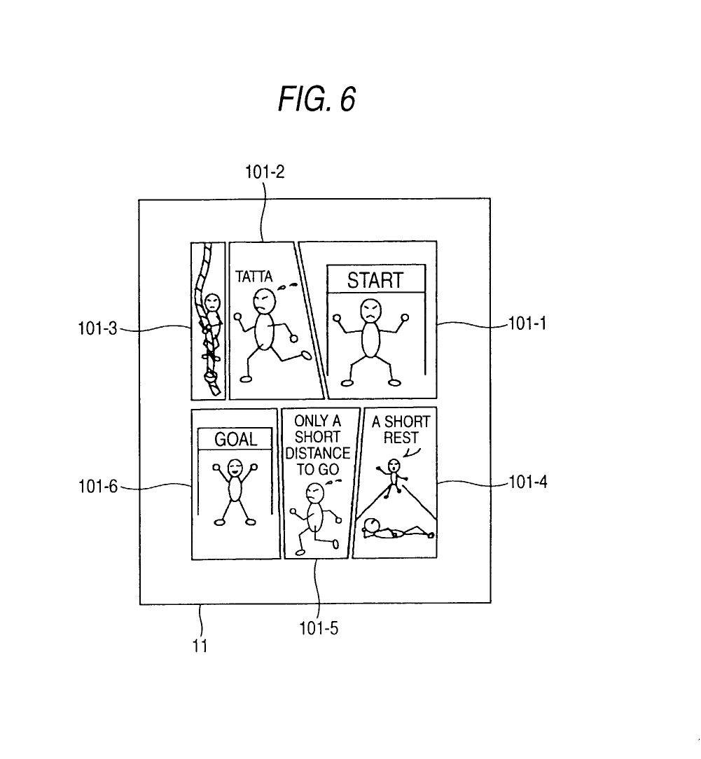

At step S6, the CPU 21 causes the display section 11 to display a comic image corresponding to the comic data. As a result, a comic image as shown in FIG. 6 is displayed on the display section 11. The comic image of FIG. 6 includes a plurality of frames 101-1 to 101-6.

At step S7, the CPU 21 judges whether an enlargement event has occurred (i.e., whether an enlargement instruction has been received from the user) or a prescribed time has elapsed. The CPU 21 repeats the judgment until an enlargement instruction is received from the user or the prescribed time elapses.

If it is judged at step S7 that an enlargement instruction has been received from the user or the prescribed time has elapsed, the process goes to step S8, where the CPU 21 reads data of a prescribed frame (in this case, the frame 101-1) among the tree-structure data that are held as a result of the execution of step S5.

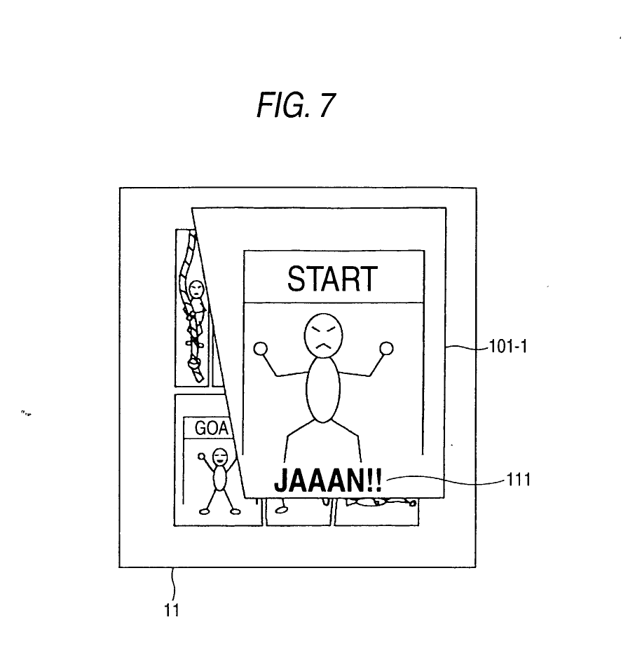

At step S9, the CPU 21 enlarges the frame concerned of the comic image being displayed on the display section 11 based on the data of a prescribed frame that were read out at step S8. In this case, the frame 101-1 is enlarged as shown in FIG. 7.

In the example of FIG. 7, as the frame 101-1 is enlarged, onomatopoeic characters “Jaaan!!” 111 are displayed that were not displayed in the ordinary display (FIG. 6) though drawn in the original picture. When the onomatopoeic characters 111 are displayed (i.e., when the frame is enlarged), the CPU 21 may cause the audio reproduction section 32 to output a sound “Jaaan.” This makes it possible to cause, more effectively, the user to read the comic story than in the case where it is printed on a comic book.

At step S10, the CPU 21 judges whether the data of all the frames have been read out. If it is judged that the data of all the frames have not been read out yet, the process returns to step S7 to execute steps S7-S10 again.

Next, steps S7-S9 will be described further in detail.

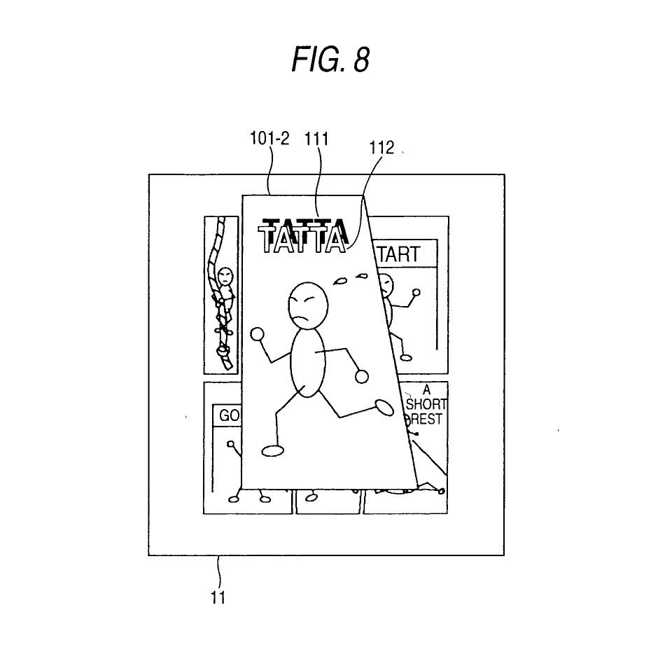

If judging at step S7 that it has received an instruction to enlarge the next frame 101-2 (i.e., the key 12a or 12b among the keys 12 has been manipulated) or the prescribed time (e.g., 10 seconds) has elapsed, the CPU 21 reads data of the frame 101-2 (step S8), finishes the enlarged display of the frame 101-1 of the comic image being displayed on the display section 11, and enlarges the frame 101-2 in, for example, a manner shown in FIG. 8 (step S9).

In the example of FIG. 8, as the frame 101-2 is enlarged, onomatopoeic characters 112 as a copy of onomatopoeic characters “Tatta” 111 that were also displayed in the ordinary display (FIG. 6) are placed by the side of the onomatopoeic characters 111 so as to be superimposed on the latter at least partially while the onomatopoeic characters 111 and 112 are moved. The CPU 21 may cause the audio reproduction section 32 to output a sound “Tatta” when the onomatopoeic characters 111 and 112 are moved.

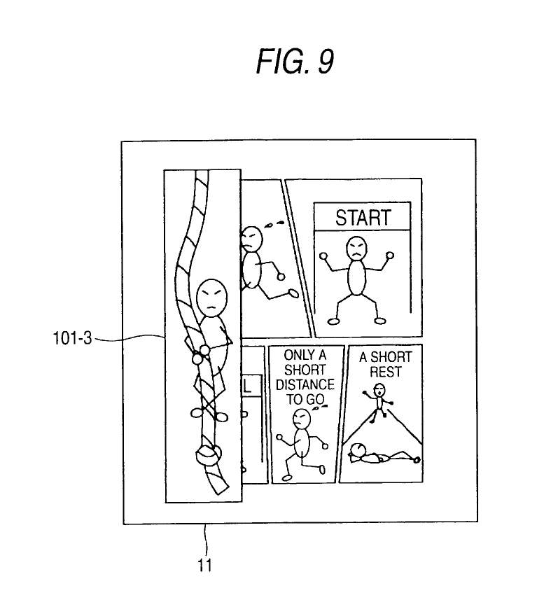

If judging that it has received an instruction to enlarge the next frame 101-3 or the prescribed time has elapsed (step S7), the CPU 21 reads data of the frame 101-3 (step S8), finishes the enlarged display of the frame 101-2 of the comic image being displayed on the display section 11, and enlarges the frame 101-3 in, for example, a manner shown in FIG. 9 (step S9).

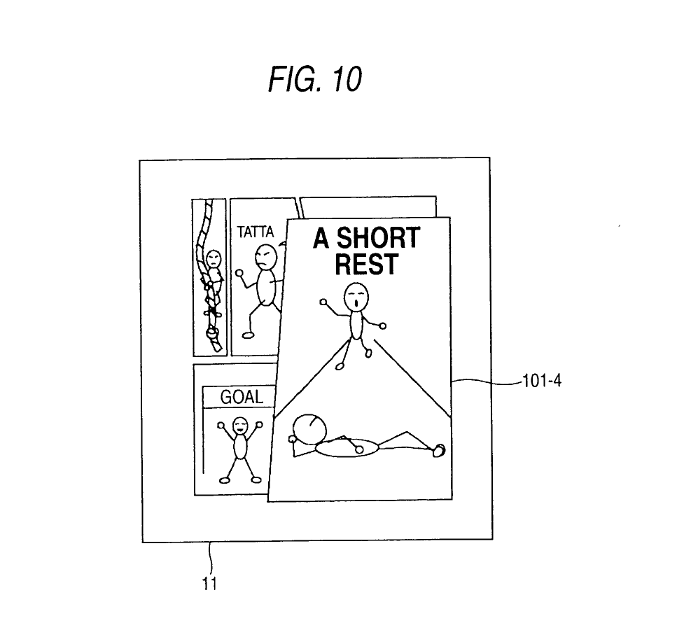

If judging that it has received an instruction to enlarge the next frame 101-4 or the prescribed time has elapsed (step S7), the CPU 21 reads data of the frame 101-4 (step S8), finishes the enlarged display of the frame 101-3 of the comic image being displayed on the display section 11, and enlarges the frame 101-4 in, for example, a manner shown in FIG. 10 (step S9).

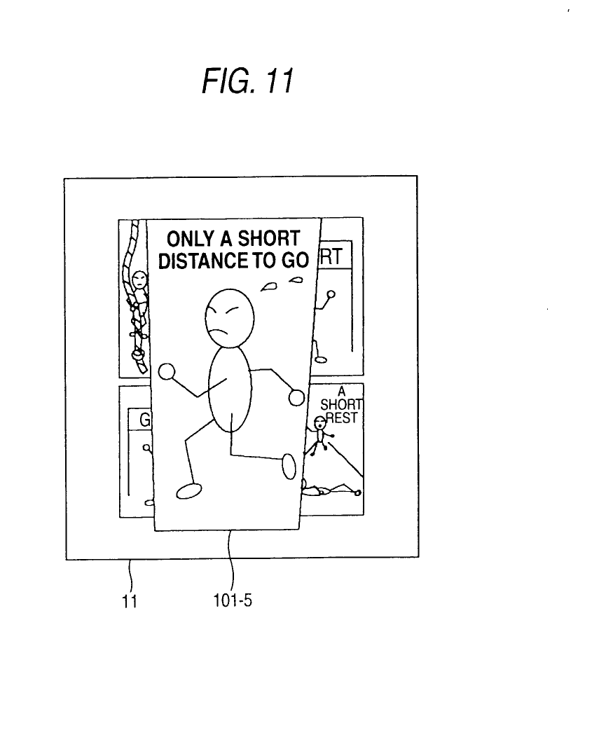

If judging that it has received an instruction to enlarge the next frame 101-5 or the prescribed time has elapsed (step S7), the CPU 21 reads data of the frame 101-5 (step S8), finishes the enlarged display of the frame 101-4 of the comic image being displayed on the display section 11, and enlarges the frame 101-5 in, for example, a manner shown in FIG. 11 (step S9).

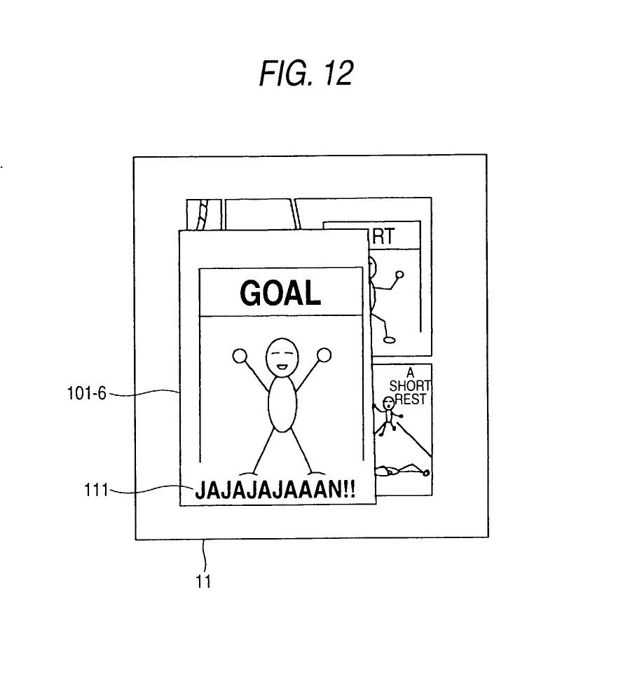

If judging that it has received an instruction to enlarge the next frame 101-6 or the prescribed time has elapsed (step S7), the CPU 21 reads data of the frame 101-6 (step S8), finishes the enlarged display of the frame 101-5 of the comic image being displayed on the display section 11, and enlarges the frame 101-6 in, for example, a manner shown in FIG. 12 (step S9).

In the example of FIG. 12, as the frame 101-6 is enlarged, onomatopoeic characters “Jajajajaaan!!” 111 that are drawn in the original picture but were not displayed in the ordinary display (FIG. 6) are displayed while being moved. The CPU 21 may cause the audio reproduction section 32 to output a sound “Jajajajaaan” when the onomatopoeic characters 111 are moved.

As described above, a frame is enlarged when it has become a frame to be seen next.

Returning to FIG. 5, if it is judged at step S10 that the data of all the frames (of one page) have been read out, the process is finished. A similar process is executed for each page.

In the above process, when a transition is made to an enlarged display of the next frame (e.g., from an enlarged display of the frame 101-1 to that of the frame 101-2), the frame 101-2 is enlarged after the enlarged display of the frame 101-1 is finished. Alternatively, the finishing of the enlarged display of the frame 101-1 and the enlargement of the frame 101-2 may be performed at the same time.

The above description is directed to the case of enlarging each frame in a state that a comic image including a plurality of frames is displayed. However, the invention is not limited to such a case. The invention makes it possible to effectively cause the user to read a comic story even in the case where only one frame is displayed each time on the display section 11.

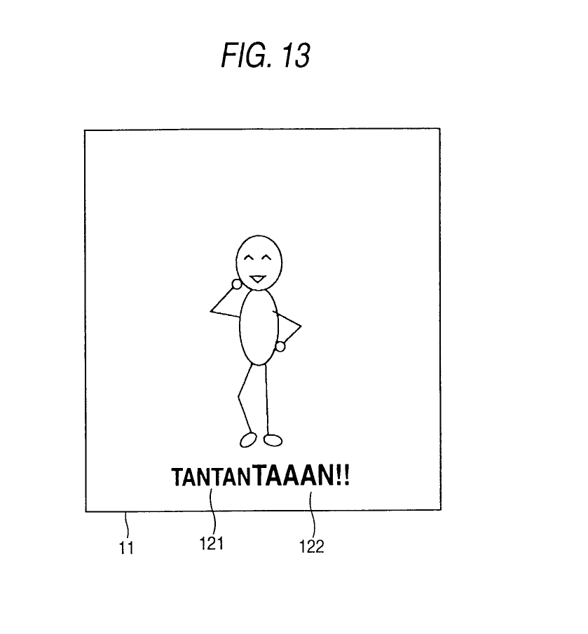

FIG. 13 shows a comic image including only one frame that is displayed on the display section 11 of the PDA 1.

The comic image of FIG. 13 includes onomatopoeic characters “Tantan” 121 and “Taaan” 122. To make the onomatopoeic characters “Tantan” 121, which should be read first in the comic story, easier to see, the user manipulates the key 12a or 12b among the keys 12 so as to scroll the image leftward.

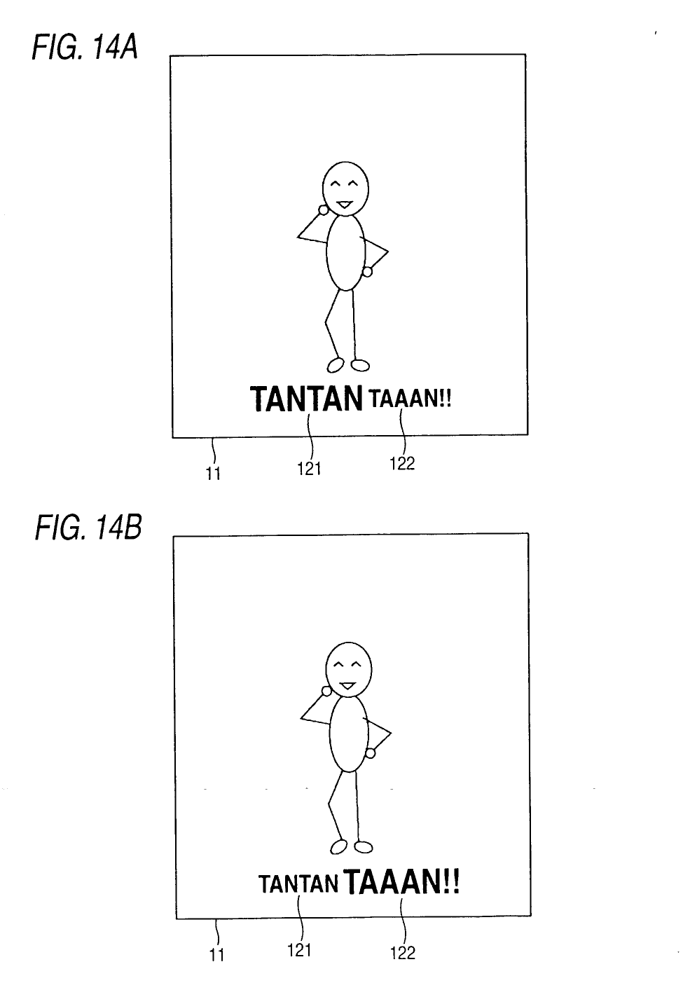

Based on a signal corresponding to the input (event) of the manipulation of the user, the CPU 21 performs a control so as to enlarge the onomatopoeic characters “Tantan” 121. As a result, the onomatopoeic characters “Tantan” 121 are enlarged as shown in FIG. 14A. Reading the characters 121, the user manipulates the key 12e or 12f among the keys 12 so as to scroll the image rightward.

Based on a signal corresponding to the input of the manipulation of the user, the CPU 21 performs a control so as to enlarge the onomatopoeic characters “Taaan” 122. As a result, the onomatopoeic characters “Taaan” 122 are enlarged as shown in FIG. 14B.

As described above, also in the case where plural sets of onomatopoeic characters are displayed on the display section 11 having a small display area, the legibility can be increased by enlarging onomatopoeic characters that have been selected by the user.

In the above example, prescribed onomatopoeic characters are enlarged based on a manipulation of the user. Alternatively, sets of onomatopoeic characters may be enlarged by using a lapse of a prescribed time as a trigger. For example, the comic image of FIG. 13 is displayed on the display section 11 and the onomatopoeic characters 121 enlarged after a lapse of a prescribed time (see FIG. 14A). After a further lapse of the prescribed time (i.e., a preset, fixed time (e.g., 10 seconds) that is long enough for the user to read the onomatopoeic characters 121), the onomatopoeic characters 122 are enlarged (see FIG. 14B).

Characters (e.g., spoken words such as “Only a short distance to go” and an explanation such as “A short rest” (see FIG. 6)) other than onomatopoeic characters may also be processed in the same manner as onomatopoeic characters. However, the application of the invention to onomatopoeic characters can more easily give a fresh feeling to the user without impairing the features of comics.

Although the above embodiment is directed to the case of displaying, on the display section 1 of the PDA 1, a comic story corresponding to comic data that are stored in the memory card 2, the invention is not limited to such a case. The invention can broadly be applied to other electronic devices having a display section and a memory card slot, such as a digital cellular phone.

Even in the case of an electronic device into which a memory card cannot be inserted directly, comic data can be read from a memory card that is mounted in a drive that is USB-connected to the electronic device via a USB port or the like.

Although in the above embodiment comic data are stored in the memory stick (memory card 2), it is naturally possible to store comic data in some other storage medium and perform processing similar to the above.

The above-described series of steps can be executed either by hardware or software. Where the series of steps are executed by software, programs that constitute the software are installed from the program storage medium to a computer that incorporates dedicated hardware or a general-purpose personal computer or the like capable of performing various functions when various programs are installed therein.

As shown in FIG. 2, a program storage medium for storing programs to be installed in a computer and thereby rendered executable by the computer is the magnetic disk 51 (including a flexible disk), the optical disc 52 (including a CD-ROM (compact disc-read only memory) and a DVD (digital versatile disc)), the magneto-optical disc 53 (including an MD (mini-disc; registered trademark)), a package medium such as the memory card 2, the flash ROM 23 in which programs are stored temporarily or permanently, a hard disc drive, or the like. Programs are stored in the program storage medium by using a wired or wireless communication medium such as a public network, a local area network, the Internet, or digital satellite broadcast through, if necessary, an interface such as the communication section 34 (e.g., a router or a modem).

The invention includes not only a process in which steps of a program to be stored in the program storage medium are executed sequentially in order as written but also a process in which they are executed parallel or individually.

In the portable information terminal, the information display control method, the recording medium, and the program according to the invention, image data stored in a memory card are read out, a one-page image corresponding to the read-out image data is displayed, and a prescribed one of a plurality of frames included in the one-page image is enlarged. Therefore, the legibility of part of a comic story that is displayed on a small screen can be increased.

What is claimed is:

1. A portable information terminal in which a memory card is to be inserted, comprising:
reading means for reading image data that are stored in the memory card; and
display control means for performing a control so as to display a one-page image corresponding to the image data that have been read by the reading means, and to enlarge a prescribed one of a plurality of frames that are included in the one-page image.

2. The portable information terminal according to claim 1, further comprising computing means for analyzing the image data that have been read by the reading means and developing the image data into data having a prescribed data structure, wherein the display control means enlarges the prescribed frame based on its developed data.

3. The portable information terminal according to claim 1, further comprising judging means for judging whether an enlargement event has occurred, the enlargement event being one of an input from a user for an enlarged display and a lapse of a prescribed time, wherein the display control means enlarges the prescribed frame based on a judgment result of the judging means.

4. The portable information terminal according to claim 1, wherein the display control means controls display of characters corresponding to an effect sound that is included in the prescribed frame in enlarging the prescribed frame.

5. The portable information terminal according to claim 4, wherein the characters corresponding to the effect sound are onomatopoeic characters.

6. The portable information terminal according to claim 5, wherein the display control means does not display the onomatopoeic characters during an ordinary display of the prescribed frame, and displays the onomatopoeic characters during an enlarged display of the prescribed frame.

7. The portable information terminal according to claim 5, wherein the display control means displays the onomatopoeic characters during an ordinary display of the prescribed frame, and displays plural sets of the onomatopoeic characters in such a manner that the plural sets of the onomatopoeic characters are superimposed on each other at least partially or arranged side by side during an enlarged display of the prescribed frame.

8. The portable information terminal according to claim 5, further comprising sound output means for outputting a sound corresponding to the onomatopoeic characters whose display is being controlled by the display control means when the prescribed frame is enlarged.

9. The portable information terminal according to claim 1, wherein the image data are comic data.

10. An information display control method of a portable information terminal in which a memory card is to be inserted, comprising:
a read control step of controlling reading of image data that are stored in the memory card; and
a display control step of performing a control so as to display a one-page image corresponding to the image data that have been read by the read control step, and to enlarge a prescribed one of a plurality of frames that are included in the one-page image.

11. A recording medium on which a computer-readable program for controlling a portable information terminal in which a memory card is to be inserted is recorded, the program comprising:
a read control step of controlling reading of image data that are stored in the memory card; and
a display control step of performing a control so as to display a one-page image corresponding to the image data that have been read by the read control step, and to enlarge a prescribed one of a plurality of frames that are included in the one-page image.

12. A program for causing a computer for controlling a portable information terminal in which a memory card is to be inserted, to execute:
a read control step of controlling reading of image data that are stored in the memory card; and
a display control step of performing a control so as to display a one-page image corresponding to the image data that have been read by the read control step, and to enlarge a prescribed one of a plurality of frames that are included in the one-page image.
